(19) United States
(12) Patent Application Publication
(10) Pub. No.: US 2007/0046195 A1
(43) Pub. Date: Mar. 1, 2007

(54) Organic light-emitting display and fabricating method thereof

(75) Inventors: Chih-Ming Chin, Chu Nan (TW); Joel Chia-Yeh Chang, Chu Nan (TW); Wen-Jeng Lan, Chu Nan (TW); Chien-Chih Chiang, Chu Nan (TW)

Correspondence Address: BIRCH STEWART KOLASCH & BIRCH, PO BOX 747, FALLS CHURCH, VA, 22040-0747, US

(73) Assignee: Univision Technology Inc.

(21) Appl. No.: 11/511,486

(22) Filed: Aug. 29, 2006

(30) Foreign Application Priority Data
Aug. 31, 2005 (TW) 94129888

(51) Int. Cl. H05B 33/00

(52) U.S. Cl. 313/506

(57) ABSTRACT

An organic light-emitting display (OLED) is provided. The OLED comprises a plurality of pixels on a substrate. Each pixel on the substrate comprises a first electrode, an organic luminescent layer and a second electrode in sequence. The first electrode comprises a first subpixel region, a second subpixel region and a third subpixel region. The organic luminescent layer comprises a first organic luminescent layer and a second organic luminescent layer. The first organic luminescent layer is above the first subpixel region and the second subpixel region. The second organic luminescent layer is above the second subpixel region and the third subpixel region. The fabricating method of the OLED is disclosed in the specification too.

### RELATED APPLICATIONS

The present application is based on, and claims priority from, Taiwan Application Serial Number 94129888, filed Aug. 31, 2005, the disclosure of which is hereby incorporated by reference herein in its entirety.

### BACKGROUND

1. Field of Invention

The present invention relates to a display and a fabricating method thereof. More particularly, the present invention relates to an organic light-emitting display and a fabricating method thereof.

2. Description of Related Art

Among the displays using in reality, the full color display technology is a key to a successful display. There are two ways to obtain a full color display for an organic light-emitting display (OLED). The first way is using three pixels of three primary colors, i.e. red, green and blue, for the OLED to obtain a full color OLED. However, the manufacturing process requires multiple evaporation processes and mask alignments to produce organic light-emitting units (OLEU) of different colors. The manufacturing process is very complicated and it is difficult to align each mask precisely. Therefore, the product yield is low and the product cost is high.

The second way is using color filter and using a white light source as a backlight source of an OLED. The radiated white light from the white light source is filtered by the color filter to obtain a full color OLED.

In FIG. 1, a cross-sectional diagram shows a conventional OLED having a color filter. The color filter 10 includes a black matrix 13 on the substrate 11 and a color filter layer 15. The color filter layer 15 is on part of the black matrix 13 and the exposed surface of the substrate 11. The color filter layer 15 comprises a first color photoresist 151 (green color), a second color photoresist 153 (blue color) and a third color photoresist 155 (red color). Optionally, a planar layer 17 is on the black matrix 13 and the color filter layer 15. The planar layer 17 may be an over coat layer or a barrier layer to facilitate the subsequent processes.

Besides, the first electrode 21 of the organic light-emitting device 20 is on the planar layer 17. An organic luminescent layer 23 and a second electrode 25 are on the first electrode 21 in sequence. When an electric current of the first electrode 21 and the second electrode 25 is conducted, the organic luminescent layer 23 produces a white light source S. The light generated by the white light source S passes through the color filter layer 15 and becomes a first color light L1, a second color light L2 and a third color light L3, which are green light, blue light and red light, respectively. Mixing the above color lights provides a full color OLED 200.

By using the color filter 10, the OLED 200 requires only a white light source S made by a white light organic light-emitting device. Therefore, the number of evaporation processes is reduced and the mask can be a full opening mask which reduces difficulty of mask alignment. However, due to the poor light transmittance of the white light source S to the color filter layer 15, the brightness and the light saturation of the OLED 200 are influenced, therefore, the quality of the OLED 200 is low.

### SUMMARY

An organic light-emitting display (OLED) is provided. The OLED comprises a plurality of pixels on a substrate. Each pixel on the substrate comprises a first electrode, an organic luminescent layer and a second electrode in sequence. The first electrode comprises a first subpixel region, a second subpixel region and a third subpixel region. The organic luminescent layer comprises a first organic luminescent layer and a second organic luminescent layer. The first organic luminescent layer is above the first subpixel region and the second subpixel region. The second organic luminescent layer is above the second subpixel region and the third subpixel region.

A manufacturing method of OLED is provided. First, a first electrode is formed on the substrate. After that, a first subpixel region, a second subpixel region and a third subpixel region are defined on the first electrode. Then, a first organic luminescent layer is formed on the first subpixel region and the second subpixel region. Moreover, a second organic luminescent layer is formed on the second subpixel region and the third subpixel region. Finally, a second electrode is formed above the first organic luminescent layer and the second organic luminescent layer.

### BRIEF DESCRIPTION OF THE DRAWINGS

These and other features, aspects, and advantages of the present invention will become better understood with regard to the following description, appended claims, and accompanying drawings where:

FIG. 1 shows a cross-sectional structure of a conventional OLED having a color filter.

FIG. 2 shows a cross-sectional view of an OLED according to an embodiment of the present invention FIG. 3 shows a cross-sectional view of an OLED according to another embodiment of the present invention.

FIG. 4 shows a cross-sectional view of an OLED according to still another embodiment of the present invention.

FIG. 5A and FIG. 5B show various steps of the manufacturing method of the passive matrix OLED according to one embodiment of the present invention.

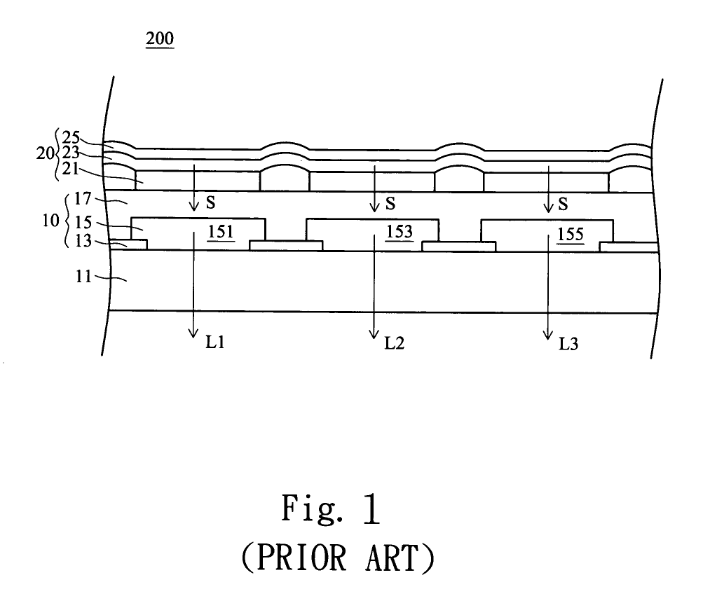

### DETAILED DESCRIPTION

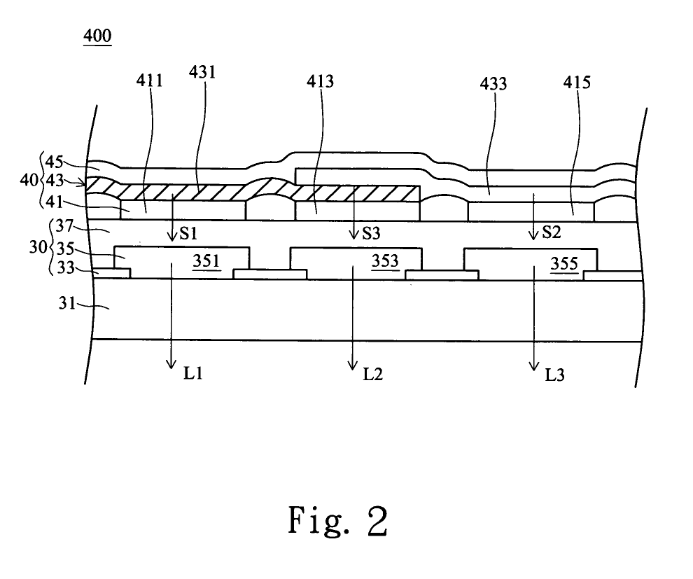

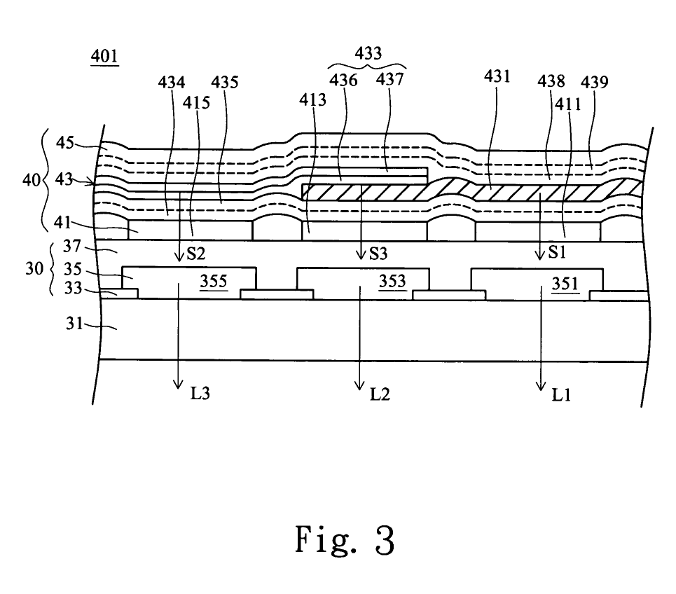

FIG. 2 shows a cross-sectional view of an organic light-emitting display (OLED) according to one embodiment of the present invention. To illustrate the embodiment of the present invention clearly, only one pixel of the OLED is shown in FIG. 2. In FIG. 2, the OLED 400 comprises a substrate 31 and an organic light-emitting device 40. The organic light-emitting device 40 includes a first electrode 41, an organic luminescent layer 43 and a second electrode 45. The organic luminescent layer 43 includes a first organic luminescent layer 431 and a second organic luminescent layer 433.

The first electrode 41, above the substrate 31, is defined to have a first subpixel region 411, a second subpixel region 413, and a third subpixel region 415. The first organic luminescent layer 431 is located above the first subpixel region 411 and the second subpixel region 413. The second organic luminescent layer 433 is located above the second subpixel region 413 and the third subpixel region 415. In the location above the second subpixel region 413, the first organic luminescent layer 431 and the second organic luminescent layer 433 are overlapped. The second organic luminescent layer 433 may be selectively located on the first organic luminescent layer 431 or between the first organic luminescent layer 431 and the first electrode 41. The second electrode 45 is located above the organic luminescent layer 43.

When the first electrode 41 and the second electrode 45 are provided with an electric current, the first organic luminescent layer 431 produces a first light source S1, the second organic luminescent layer 433 produces a second light source S2, the overlap of the first organic luminescent layer 431 and the second organic luminescent layer 433 produces a third light source S3.

In the embodiment given above, the OLED 400 may further comprises a color filter 30, located between the substrate 31 and the organic light-emitting device 40. The color filter 30 comprises a black matrix 33 and a first color filter layer 35. The black matrix 33 is on the substrate 31, the first color filter layer 35 is on the substrate 31 and part of the black matrix 33. The first color filter layer 35 includes a first color photoresist 351, a second color photoresist 353, and a third color photoresist 355. The first color photoresist 351 is located on the vertically extended region of the first subpixel region 411; the second color photoresist 353 is located on the vertically extended region of the second subpixel region 413; the third color photoresist 355 is located on the vertically extended region of the third subpixel region 415. The location above the black matrix 33 and the first color filter layer 35 may have a planar layer 37, the planar layer 37 may be an over coat layer, a barrier layer or a combination thereof.

The first organic luminescent layer 431 is overlaid above the first subpixel region 411 and the second subpixel region 413. The second organic luminescent layer 433 is overlaid above the second subpixel region 413 and the third subpixel region 415. As mentioned above, the first organic luminescent layer 431 and the second organic luminescent layer 433 are respectively overlaid on two subpixel regions; therefore, it reduces number and difficulty of mask alignments during evaporation process.

The light from the first light source S1 produced by the first organic luminescent layer 431 passes through the first color photoresist 351 directly and is filtered into a first color light L1. The light from the second light source S2 produced by the second organic luminescent layer 433 passes through the third color photoresist 355 directly and is filtered into a third color light L3. In the location above the second subpixel region 413, the overlap of the first organic luminescent layer 431 and the second organic luminescent layer 433 produces a third light source S3. The light from the third light source S3 passes through the second color photoresist 353 and is filtered into a second color light L2. By using a combination of the first color light L1, the second color light L2 and the third color light L3, it will provide a full color display outcome for the OLED 400.

In one embodiment, the first light source S1 produced by the first organic luminescent layer 431 is a blue light source. The second light source S2 produced by the second organic luminescent layer 433 may be a complementary light source of the first light source S1; for examples, it may be a green light source, a yellow light source, an orange light source or a red light source. The third light source S3 produced by the overlap of the first organic luminescent layer 431 and the second organic luminescent layer 433 is a white light source. The first color photoresist 351, the second color photoresist 353 and the third color photoresist 355 are a blue color photoresist, a green color photoresist and a red color photoresist. Thus, the light from the first light source S1 (blue light) passes through the first color photoresist 351 (blue color photoresist) and is further filtered into the first color light L1 (blue light). The light of the second light source S2 (green, yellow, orange or red light source) passes through the third color photoresist 355 (red color photoresist) and is further filtered into the third color light L3 (red light). The light of the third light source S3 (white light source) passes through the second color photoresist 353 (green color photoresist) and is further filtered into the second color light L2 (green light).

The first color filter layer 35 only allows light with a specific wavelength range to pass. For example, if the first color photoresist 351 allows a light having a wavelength within a range between 400 nm˜500 nm (blue light region) to pass and a white light source is used as the backlight source, only part of the white light having a wavelength within 400 nm˜500 nm can pass the first color filter layer 35 to generate a blue light. Other part of the white light is filtered out. Therefore, the light transmittance of the first color photoresist 351 for a white light is only about 25%, which is quite low.

On the contrary, if the wavelength range of the light from the first light source S1 is in the range that is allowed to pass through the first color photoresist 351, light transmittance of the first light source S1 passing through the first color photoresist 351 is better. For example, if the wavelength of the light from the first light source S1 is in the range between 420 nm˜470 nm (blue light) and the first color photoresist 351 allows light with wavelength range between 400 nm˜500 nm to pass, most of the light from the first light source S1 will pass the first color photoresist 351. In one embodiment of the present invention, the light transmittance of the color photoresist is above 80%. Thus, the light intensity can be largely increased.

By using the OLED 400 in one embodiment of the present invention, light transmittance, light intensity and light saturation of a specific light source are increased. Besides, depending on the application and scope of the OLED 400, different type of the first organic luminescent layer 431 and the second organic luminescent layer 433 can be selected to generate different color. Therefore, it will increase light transmittance, light intensity and light saturation of the OLED 400. Besides, the lifetime of the device will be longer and the power consumption will be reduced.

According to one embodiment of the present invention, the material of the first organic luminescent layer 431 or the second organic luminescent layer 433 may be at least one organic host emitter doped with at least one dopant.

According to another embodiment of the present invention, the first light source S1 produced by the first organic luminescent layer 431 may also be a red light source or a green light source. The first color photoresist 351 corresponding to the first light source S1 may also be a red color photoresist or a green color photoresist accordingly. A full color display can also be achieved for the OLED 400.

According to another embodiment of the present invention, the OLED 400 further comprises plural thin film transistors (TFTs) (not shown in the drawing). Each of the TFTs is electrically connected to the first electrode 41 on the first subpixel region 411, the second subpixel region 413 or the third subpixel region 415, respectively, to form an active matrix OLED. The active matrix OLED may be a color filter on array (COA) structure or an array on color filter (AOC) structure, depending on the location of the TFTs.

In FIG. 3, a cross-sectional diagram shows an OLED according to another embodiment of the present invention. The substrate 31, the color filter 30 and the first electrode 41 are positioned similarly to that shown in FIG. 2. In this embodiment, the first organic luminescent layer 431 is above the first subpixel region 411 and the second subpixel region 413. The second organic luminescent layer 433 is above the second subpixel region 413 and the third subpixel region 415. The first color photoresist 351, the second color photoresist 353 and the third color photoresist 355 are on the vertically extended region of the first subpixel region 411, the second subpixel region 413 and the third subpixel 415, respectively.

The organic light-emitting device 40 may further selectively include a hole injection layer (HIL) 434, a hole transporting layer (HTL) 435, an electron transporting layer (ETL) 438, an electron injection layer (EIL) 439 or a combination thereof. For example, the hole injection layer (HIL) 434 and the hole transporting layer (HTL) 435 are located below the first organic luminescent layer 431 and the second organic luminescent layer 433, the electron transporting layer (ETL) 438 and the electron injection layer (EIL) 439 are located above the first organic luminescent layer 431 and the second organic luminescent layer 433, as shown in FIG. 3. Accordingly, the HIL 434, the HTL 435, the organic luminescent layer 43, the ETL 438, the EIL 439 or a combination thereof is between the first electrode 41 and the second electrode 45.

Moreover, the first organic luminescent layer 431 and the second organic luminescent layer 433 may be a mono organic luminescent layer or a multiple organic luminescent layers. For example, the first organic luminescent layer 431 is a mono organic luminescent layer, and the second organic luminescent layer 433 is multiple organic luminescent layers having a third organic luminescent layer 436 and a fourth organic luminescent layer 437. The first organic luminescent layer 431 may radiate blue light. The third organic luminescent layer 436 and the fourth organic luminescent layer 437 may radiate orange light and yellow light, respectively. By overlapping the third organic luminescent layer 436 and the fourth organic luminescent layer 437, the second organic luminescent layer 433 produces the second light source S2.

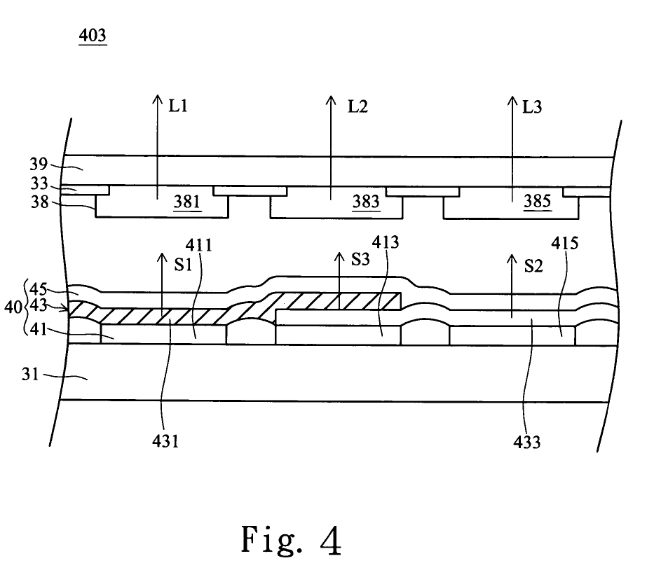

In FIG. 4, a cross-sectional diagram shows an OLED according to one embodiment of the present invention. The OLED 403 includes a substrate 31 and an organic light-emitting device 40, positioned similarly to the substrate 31 and the organic light-emitting device 40 in FIG. 2. However, the second organic luminescent layer 433 above the second subpixel region 413 is between the first organic luminescent layer 431 and the first electrode 41. Undoubtedly, the second organic luminescent layer 433 above the second subpixel region 413 also can be on the first organic luminescent layer 431 as shown in FIG. 2.

The OLED 403 further comprises a cover 39 over the substrate 31 and the organic light-emitting device 40 to protect the organic light-emitting device 40. The bottom of the cover 39 comprises a second color filter layer 38. The second color filter layer 38 comprises a fourth color photoresist 381, a fifth color photoresist 383 and a sixth color photoresist 385. The fourth color photoresist 381 is on the vertically extended region of the first subpixel region 411. The fifth color photoresist 383 is on the vertically extended region of the second subpixel region 413. The sixth color photoresist 385 is on the vertically extended region of the third subpixel region 415.

The fourth color photoresist 381, the fifth color photoresist 383 and the sixth color photoresist 385 individually filter the light from the first light source S1, the second light source S2 and the third light source S3 produced by the organic luminescent layer 43. The material of the second electrode 45 may be a transparent conductive material, therefore, the light of the first light source S1, the second light source S2 and the third light source S3 can pass through the second electrode 45.

In one embodiment, the OLED 403 further comprises a plurality of TFTs (not shown in the drawing). Each of the TFTs is electrically connected to the first electrode 41 on the first subpixel region 411, the second subpixel region 413 or the third subpixel region 415, respectively, to form an active matrix OLED.

In FIG. 2, the first color filter layer 35 is between the substrate 31 and the organic light-emitting device 40. The OLED 400 is bottom-emission type. In FIG. 4, the second color filter layer 38 is under the cover 39. The OLED 403 is top-emission type. It may also use both of the first color filter layer 35 in FIG. 2 and the second color filter layer 38 in FIG. 4 to obtain a double-faced OLED.

According to one embodiment in the present invention, the double-faced OLED further comprises a plurality of TFTs. Each of the TFTs is electrically connected to the first electrode 41 on the first subpixel region 411, the second subpixel region 413 or the third subpixel region 415, respectively, to form an active matrix OLED.

In the embodiments given above, the location of the first subpixel region 411, the second subpixel region 413 and the third subpixel region 415 are exchangeable, the corresponding color photoresist 351, 353, 355, 381, 383 and 385 should be arranged to the suitable location according to the corresponding subpixel 411, 413 and 415. For example, the second subpixel region 413 may be between the first subpixel region 411 and the third subpixel region 415, the first subpixel region 411 may be between the second subpixel region 413 and the third subpixel region 415, or the third subpixel region 415 may be between the first subpixel region 411 and the second subpixel region 413. Certainly, the location of the first organic luminescent layer 431 and the second organic luminescent layer 433 should be changed according to the location of the subpixel 411, 413 and 415.

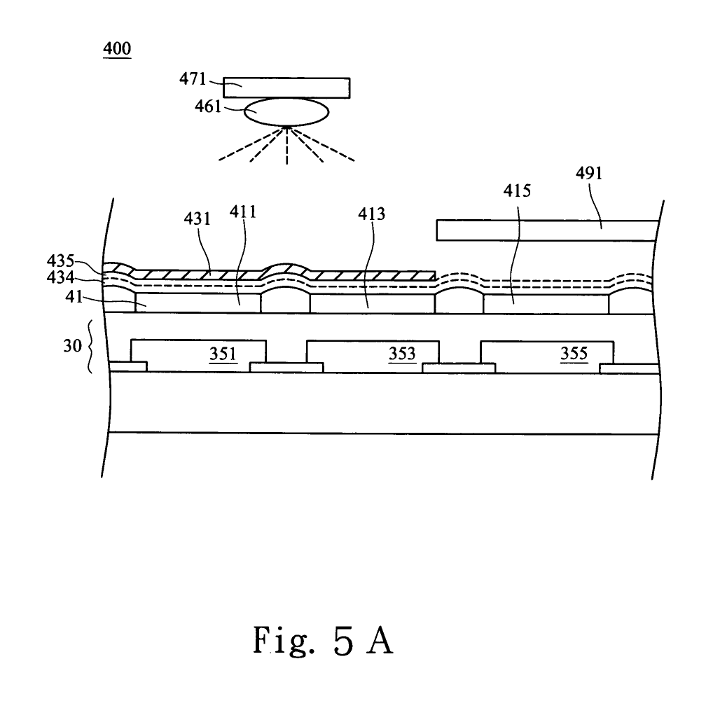

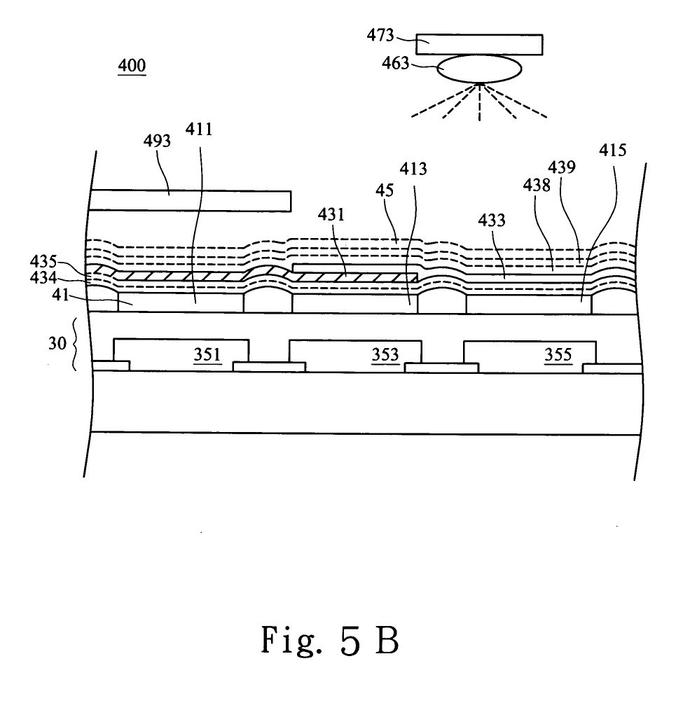

In FIG. 5A and FIG. 5B, the cross-sectional diagram shows various steps of the manufacturing method of the passive matrix OLED according to one embodiment of the present invention. To illustrate the embodiment of the present invention, the drawing shows a single pixel of the OLED. In FIG. 5A and FIG. 5B, after forming a first electrode 41 on the color filter 30, the evaporation is proceeded to form the HIL 434 and/or the HTL 435 on the electrode 41. The forming method of the first electrode 41 and the prior process can be achieved by any conventional skills. Moreover, the first organic luminescent layer 431 and the second organic luminescent layer 433 are formed on the HTL 435. Finally, the ETL 438, the EIL 439 and the second electrode 45 are formed in sequence on the first organic luminescent layer 431 and the second organic luminescent layer 433. Besides, the first electrode 41, above the substrate 31, is defined to have a first subpixel region 411, a second subpixel region 413, and a third subpixel region 415. The detailed description of the manufacturing method is provided in below.

In FIG. 5A, a first mask 491 is located on the vertically extended region of the third subpixel 415 to shield the third subpixel region 415. A first evaporation source 471 is used to form the first organic luminescent layer 431 above the first subpixel region 411 and the second subpixel region 413. A first organic light-emitting material 461 is used in evaporation process to produce the first organic luminescent layer 431.

In one embodiment of the present invention, before the formation of the first organic luminescent layer 431, it may form the HIL 434 and/or the HTL 435 on the first electrode 41.

After that, referring to the FIG. 5B, a second mask 493 is located on the vertically extended region of the first subpixel region 411 to shield the first subpixel region 411. A second evaporation source 473 is used to form the second organic luminescent layer 433 on the first electrode 41 (or HTL 435) and the first organic luminescent layer 431. As shown in FIG. 5B, a second organic light-emitting material 463 is used in evaporation process to form the second organic luminescent layer 433.

In one embodiment of the present invention, the first light source S1 is produced by the first organic luminescent layer 431 and the second light source S2 is produced by the second organic luminescent layer 433. The first light source S1 and the second light source S2 are complementary light source. The first organic luminescent layer 431 and the second organic luminescent layer 433 are composed of the first organic light-emitting material 461 and the second organic light-emitting material 463, respectively. The first organic light-emitting material 461 may be a material producing blue light and the second organic light-emitting material 463 may be a material producing orange light.

In one embodiment in the present invention, the forming sequence of the first organic luminescent layer 431 and the second organic luminescent layer 433 are exchangeable. For example, the second organic luminescent layer 433 is formed prior to the formation of the first organic luminescent layer 431. First, the second mask 493 is located on the vertically extended region of the first subpixel region 411 to shield the first subpixel region 411. After that, an evaporation is performed to form the second organic luminescent layer 433 above the second subpixel region 413 and the third subpixel 415. Then, the first mask 491 is located on the vertically extended region of the third subpixel region 415, the evaporation is performed to deposit the first organic luminescent layer 431 above the first subpixel region 411 and the second subpixel 413.

After finishing the formation of the first organic luminescent layer 431 and the second organic luminescent layer 433, the rest manufacturing process of the OLED 400 is continuously accomplished. For example, the ETL 438 and/or the EIL 439 and the second electrode 45 are formed in sequence, shown as dotted line in the FIG. 5B.

In each pixel according to the embodiment of the present invention, the first organic luminescent layer 431 and the second organic luminescent layer 433 are above two subpixels. Therefore, a larger opening mask can be used in the evaporation process. It will further decrease the difficulty of alignment in the evaporation process.

Compared to using three pixels of three primary colors, the number and the difficulty of the evaporation process to form the organic light-emitting devices can be reduced. It will further increase the product yield.

Certainly, the manufacturing process described above can be used in the active matrix OLED too.

Accordingly, the OLED and the manufacturing method described in the embodiment of the present invention not only increase the light transmittance and the color saturation of the light source, but also reduce power consumption and obtain longer lifetime. Besides, product yield can be increased because of relatively simple manufacturing process.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic light-emitting display comprising a plurality of pixels located on a substrate, wherein each of the pixels comprises:
a first electrode located on the substrate and having a first subpixel region, a second subpixel region and a third subpixel region;
a first organic luminescent layer located above the first subpixel region and the second subpixel region;
a second organic luminescent layer located above the second subpixel region and the third subpixel region; and
a second electrode located on the first and the second organic luminescent layers.

2. The organic light-emitting display of claim 1, wherein the second organic luminescent layer above the second subpixel region is on the first organic luminescent layer or under the first organic luminescent layer.

3. The organic light-emitting display of claim 1, further comprising a color filter between the substrate and the first electrode, the color filter comprising a first color filter layer, which comprises a first color photoresist, a second color photoresist and a third color photoresist located on the vertically extended region of the first subpixel region, the second subpixel region and the third subpixel region, respectively.

4. The organic light-emitting display of claim 3, further comprising a plurality of thin film transistors being electrically connected to the first electrode on the first subpixel region, the second subpixel region and the third subpixel region, respectively.

5. The organic light-emitting display of claim 3, further comprising a planar layer on the first color filter layer, wherein the planar layer is an over coat layer, a barrier layer or a combination thereof.

6. The organic light-emitting display of claim 3, further comprising a cover located above the substrate, the bottom of the cover having a second color filter layer, which comprises a fourth color photoresist, a fifth color photoresist and a sixth color photoresist located on the vertically extended region of the first subpixel region, the second subpixel region and the third subpixel region, respectively.

7. The organic light-emitting display of claim 6, further comprising a plurality of thin film transistors being electrically connected to the first electrode on the first subpixel region, the second subpixel region and the third subpixel region, respectively.

8. The organic light-emitting display of claim 1, further comprising a cover located above the substrate, the bottom of the cover having a second color filter layer, which comprises a fourth color photoresist, a fifth color photoresist and a sixth color photoresist located on the vertically extended region of the first subpixel region, the second subpixel region and the third subpixel region, respectively.

9. The organic light-emitting display of claim 8, further comprising a plurality of thin film transistors being electrically connected to the first electrode on the first subpixel region, the second subpixel region and the third subpixel region, respectively.

10. The organic light-emitting display of claim 1, further comprising a hole injection layer, a hole transporting layer, an organic luminescent layer, an electron transporting layer, an electron injection layer or a combination thereof between the first electrode and the second electrode.

11. The organic light-emitting display of claim 1, wherein the first organic luminescent layer and the second organic luminescent layer comprise an organic luminescent layer selected from a group consisting of mono-layer organic luminescent layer, multiple-layer organic luminescent layer and a doped organic luminescent layer.

12. The organic light-emitting display of claim 1, wherein the first organic luminescent layer produces a first light source, the second organic luminescent layer produces a second light source, and the overlap of the first organic luminescent layer and the second organic luminescent layer produces a third light source.

13. The organic light-emitting display of claim 12, wherein the first light source and the second light source are complementary light sources.

14. A method of manufacturing organic light-emitting display comprising:
forming a first electrode on the substrate;
defining a first subpixel region, a second subpixel region and a third subpixel region on the first electrode;
forming a first organic luminescent layer on the first and the second subpixel regions;
forming a second organic luminescent layer on the second and the third subpixel regions; and
forming a second electrode above the first and the second organic luminescent layers.

15. The organic light-emitting display manufacturing method of claim 14, wherein the forming procedure of the first organic luminescent layer comprises:
using a first mask to shield the third subpixel region; and
using a first evaporation source to deposit the first organic luminescent layer on the first and the second subpixel region.

16. The organic light-emitting display manufacturing method of claim 14, wherein the forming procedure of the second organic luminescent layer comprises:
using a second mask to shield the first subpixel region; and
using a second evaporation source to deposit the second organic luminescent layer on the second and the third subpixel region.
